(19) United States
(12) Patent Application Publication
(10) Pub. No.: US 2016/0156919 A1
(43) Pub. Date: Jun. 2, 2016

(54) Stand Alone Text overlay (insertion) of Data External to a Camera Source or External to the Original Video Source on Compressed Digital Video.

(71) Applicant: David A. Starling, Mount Juliet, TN (US)

(72) Inventor: David A Starling, Mount Juliet, TN (US)

(73) Assignee: VRX COMPANY INC., Maryville, TN (US)

(21) Appl. No.: 14/920,653

(22) Filed: Oct. 22, 2015

Related U.S. Application Data
(60) Provisional application No. 62/122,569, filed on Oct. 24, 2014.

(51) Int. Cl. H04N 19/46; H04N 5/278; H04N 21/4363; H04N 5/265

(52) U.S. Cl. CPC H04N 19/46; H04N 5/265; H04N 5/278; H04N 21/43632; H04N 21/43637

(57) ABSTRACT

A Text Inserter for Compressed Digital Video is described useful for capturing information in the data domain of text and combining in the video domain forming a joint history of the two domains. The Text Inserter works stand alone, overlaying text onto compressed digital video from cameras or other video sources. The overlay is in real time (exclusive of typical compression latency or even compensating for source compression latency). This joint domain video can be viewed on monitors or recorded or both for real time use or archival use.

### CROSS REFERENCE TO RELATED APPLICATIONS

This application claims the benefit of Provisional Patent Application Ser. No. 62/122,569 U.S.PTO issued Oct. 24, 2014 by the present inventor, which is incorporated by reference.

### STATEMENT OF FEDERALLY SPONSORED RESEARCH/DEVELOPMENT

There were no federal expenditures or sponsorships of this research or development.

### BACKGROUND OF THE INVENTION

For many years there have existed stand alone devices capable of inserting text on analog time continuous video of the many TV system types found world wide, NTSC, PAL and SECAM being the majority. These devices are not compatible with compressed digital video. The same needs met by these stand alone devices for analog video exists for compressed digital video and our invention, a stand alone Text Inserter for Compressed Digital Video, fills that need. There is no other product like in the market.

### SPECIFICATION

### Background and Statement of Opportunity

In many applications analog insertion of text onto video has been useful to add value neither the text nor the video have separately. Common applications include Point of Sale environment, electronic scales, and other telemetry applications where a measurement related to something in the video or coincident with the video have additional meaning by combining with video. However analog text inserters cannot insert the text onto the much higher resolution cameras entering the market using compressed digital videol. Many such cameras never offer an external output of the video in a time domain sequence where traditional analog text insertion can be implemented. Further the analog text inserters on the market target standard definition television signals such as the 525 line NTSC or 625 line PAL/SECAM signals. The flexibility of higher line counts including but not limited to 720P and 1080P of Higher Definition video formats requires a corresponding flexibility of text insertion.

What is needed is a solution compatible with the compressed digital signals.

### The Proposed Solution Provide a digital platform and software to embody the solution needed to combine text and video using current processing technology.

### Field of the Invention

This invention pertains to the field of Compressed Digital Video from Cameras or other video sources to which telemetry data in the form of text overlay is added in real time or very near real time. The data added is added by a stand alone device not in the camera or video source because the camera or video source manufacturers did not make provision for such data and so insertion on the compressed video becomes required.

### SUMMARY OF THE INVENTION

The invention is a text inserter as is typically used in a point of sale environment or ATM environment. This text inserter examines the data it receives in the normal course of operation for words or control codes associated with exception events.

### DRAWINGS AND DESCRIPTIONS

FIG. 1 is a diagram of the interconnection of the proposed system.

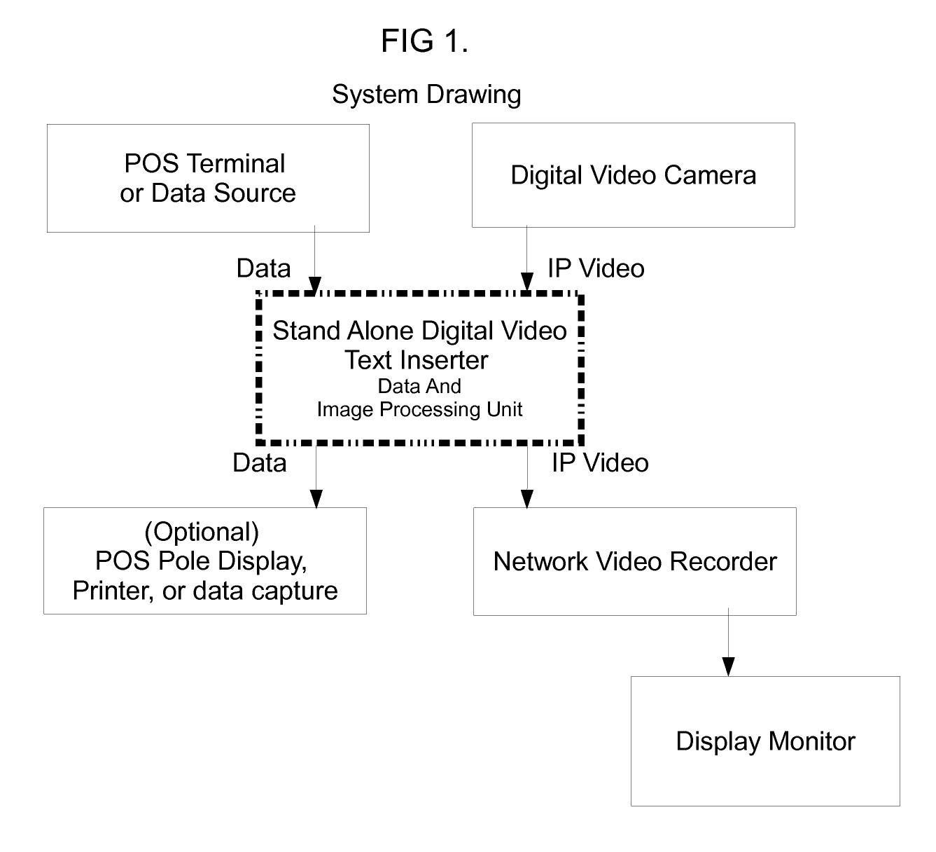

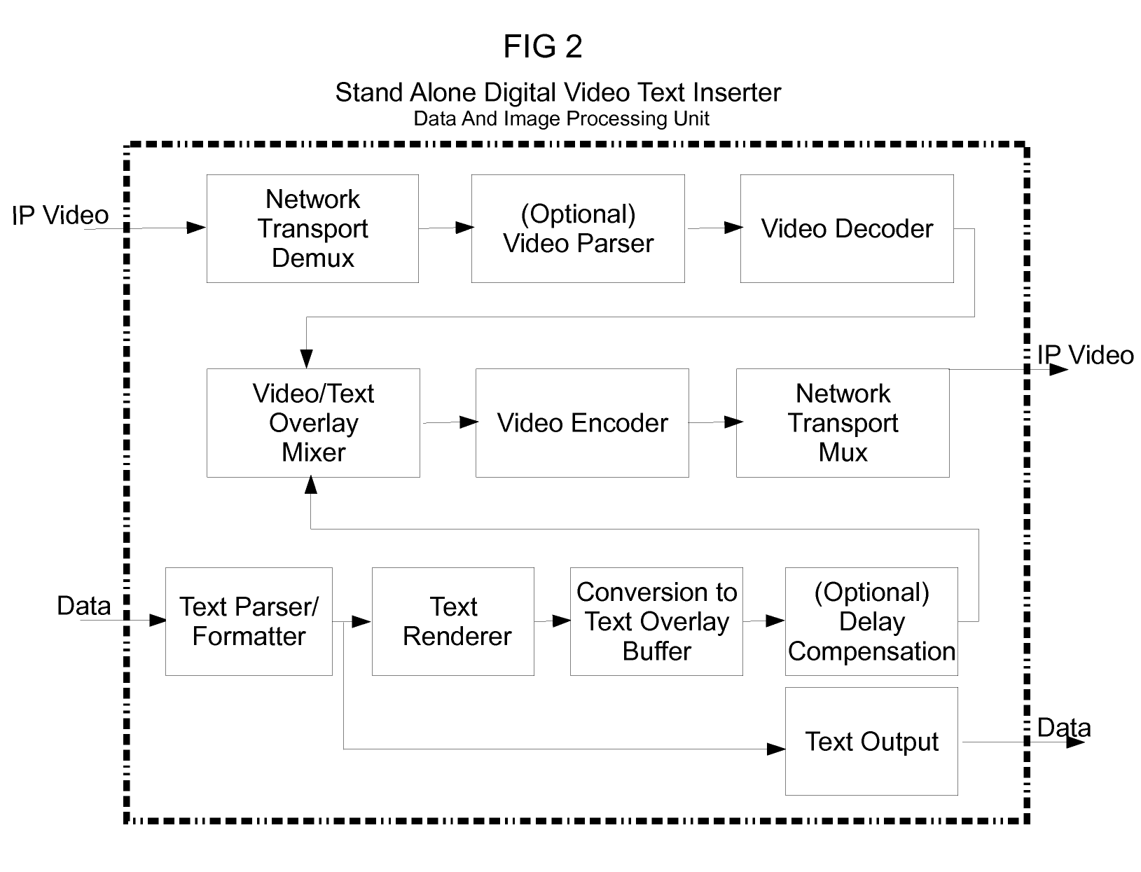

The system includes:

A source of data including but not limited to Point of Sale (POS Terminal), a cash register, a scale with electronic output, a radar gun, a temperature meter or other telemetry expressed as text.

A source of compressed Digital Video such as from a camera or computer generated into which the text is to be inserted. The camera is typically but not exclusively pointed at the source of the text. The camera may be pointed at something to capture the correlation of the text to an independent event.

A video recorder and or monitor which are often combined together (but may be separate) Other devices may received the data. The date may be intended for another receiver and the Text Inserter my be connected inline because the Data Source never anticipated or provided dedicated interface for the Text Inserter. The Text Inserter may provide data reformatting and may translate to other interface types such as, but not limited to, translation from Serial COM port input to IP port.

FIG. 2 is a detail diagram of the processing setups comprising the implementation of the

Stand Alone, compressed Digital Video Text Inserter. The diagram shows the inputs and outputs. Here “IP Video” is used as a short hand for any of the multiplicity of connections types of claims 2 and 3.

Here “Data” is used as a short hand for any of the multiplicity of connections types of claims 4 and 5.

### DETAILED DESCRIPTION OF THE INVENTION AND THE PREFERRED EMBODIMENT

Compressed Digital Video is input on a digital interface. If required the video is de-multiplexed from other data services such as audio.

The Video Decoder transforms the compressed video back into the time domain.

The text Parser/Formatter receives the text data and may strip control characters or parse a particular stream of data from a multiplexed stream.

The Text Renderer receives the parsed/reformatted text data and generates text for overlay onto the video. This may be done in a graphic layer and then mixed or blended into the video or it may be generated and written directly into the video.

Because the Video Decoding may have some latency, delay compensation may be added to the Text Path so that the inserted text has the proper temporal relation to the video at the mixing step.

The Mixer receives the time domain video and the image of the text to be inserted. The text has an alpha value where it is blended and or replaces the time domain video. The Time Domain video is a background to the text with the text taking partial or complete precedence.

The mixed video is then encoded, re-compressed into an elementary video stream.

The video stream is multiplexed with other services such as audio and into a transport stream and output from the Text Inserter.

The input text data may also be forwarded to other peripherals which may have been the intended natural target of the data.

What is claimed is a stand alone text inserter for compressed digital video with features of these claims:

1. A video text insertion device comprising a means for receiving compressed digital video, with or without audio, Inserting a text overlay into the video permanently altering the video with the text, and delivering the modified video to other devices for viewing or storage.

2. A device of claim 1, which receives compressed digital video in from other devices on a multiplicity of interface port types such as but not limited to USB Host Ports, USB Device Ports, IP ports, IR Ports, RF ports.

3. A device of claim 1, which forwards the video with inserted text out to other devices on a multiplicity of interface port types such as but not limited to USB Host Ports, USB Device Ports, IP ports, IR Ports, RF ports.

4. A device of claim 1, which receives text in from other devices on a multiplicity of interface port types such as but not limited to serial COM ports, USB Host Ports, USB Device Ports, IP ports, IR Ports, RF ports.

5. A device of claim 1, which forwards the received text out to other devices on a multiplicity of interface port types such as but not limited to serial COM ports, USB Host Ports, IP ports, IR Ports, RF ports.

6. A device of claim 1, with any combination of claims 2, 3, 4 and 5.

7. A device of claim 6 with servicing a multiplicity of data sources and compressed digital video sources and servicing a multiplicity of video recorders and monitors.
